(19) United States
(12) Patent Application Publication
(10) Pub. No.: US 2011/0037584 A1
(43) Pub. Date: Feb. 17, 2011

(54) Securing electrically-operated devices in a moving vehicle

(75) Inventors: Thomas Arthur Kenny, Troy, MI (US); Timonthy P. Lyon, Daerborn, MI (US); Steven Fister, Tuscon, AZ (US); Ernest Pacsai, Wixom, MI (US); James Richard Heim, Kakamazoo, MI (US); Robert Lawerence Gilling, Caro, MI (US)

Correspondence Address: Currie Kendall PLC, 6024 Eastman Ave, Midland, MI, 48640-2518, US

(73) Assignee: Wireless on Water LLC

(21) Appl. No.: 12/806,313

(22) Filed: Aug. 10, 2010

Related U.S. Application Data
(60) Provisional application No. 61/232,969, filed on Aug. 11, 2009.

(51) Int. Cl. G08B 5/22

(52) U.S. Cl. 340/480

(57) ABSTRACT

A shut off safety device and method for reducing accidental activation of electrically controlled devices in a vehicle such as awnings, electrically controlled jacks, electrically controlled brakes in a towed RV is described and claimed. Instead of the electrically controlled device being deactivated based on the memory of a human to do a safety shut off device comprising a controller that is automatically activated in response to an act occurring within that or a second vehicle associated with said first vehicle, to provide a shutdown signal, a RF receiver responsive to the activation of the controller to provide a second signal, and an electrical means associated with said electrically activated and operated device said electrical means being responsive to said second signal to shut down and de-energize said device until reactivated by an operator of said vehicle.

### CROSS REFERENCE TO RELATED APPLICATION

This application claims priority to provisional patent application Ser. No. 61/2322,969, filed Aug. 11, 2009. The teaching thereof are specifically incorporated herein by reference.

### FIELD OF THE DISCLOSURE

The present disclosure relates generally to circuit breakers. More specifically, the present disclosure relates to disconnecting a circuit or circuits within a moving vehicle.

### BACKGROUND

Manual or electromechanical switches (e.g., solenoids, relays, and latching relays) can be used to disconnect one or more circuits in a vehicle that is being towed or a vehicle that is being driven. In one particular example, an electromechanical switch may be used to disconnect one or more circuits in a vehicle that is being towed or transported, such as a trailer or a boat. In a second particular example, an electromechanical switch may be used to disconnect one or more circuits in a vehicle that is being driven, such as a recreational vehicle (“RV”).

### SUMMARY OF THE INVENTION

In summary the invention comprises a vehicle having at least one electrically activated and operated device such as an electrically operated jack system, a safety shut off device comprising: a controller that is automatically activated in response to an act occurring within that or a second vehicle associated with said first vehicle, to provide a shutdown signal,

a RF receiver responsive to the activation of the controller to provide a second signal, and an electrical means associated with said electrically activated and operated device said electrical means being responsive to said second signal to shut down and de-energize said device until reactivated by an operator of said vehicle. The first vehicle is for example an RV which is motorized or is towed by a second vehicle. The activating can act be for example applying pressure to a braking system or for example the vehicle starting in motion.

### DETAILED DESCRIPTION

Recently, manufacturers of recreational vehicles (“RVs”) have begun installing electrically-operated devices such as jacks (both front and rear), slides, and motorized awnings, for example. These electrically-operated devices can be controlled by radio frequency devices as well as with momentary or hard ON switches. With the adoption of this technology, it has become important for users of this technology to reduce the potential for inadvertent activation of these electrically-operated devices. For example, if one of these electrically-operated devices was to be inadvertently activated on a trailer that is being towed or on an RV that is being driven, a hazardous or even disastrous situation could be created. One of these electrically-operated devices could be inadvertently activated, for example, when an electrical short within a system occurs or by inadvertent activation of a remote control device (e.g., a FOB). While the use of electromechanical switches may address the concern of inadvertent activation of electrically-operated devices on a vehicle being towed or a vehicle being driven, a responsible operator cannot guarantee that prior to towing or driving a vehicle that power to the electrically-operated devices in the vehicle will be turned off initially and then remain turned off the entire time the vehicle is being towed or driven.

Some electrically-operated devices are configured to require a sequence of multiple button presses on a remote fob to be activated. The sequence of button presses can be customized to meet different original equipment manufacturer (“OEM”) requirements. Although requiring a sequence of button presses to activate an electrically-operated device may reduce the potential for inadvertent activation of the electrically-operated device, it is not a fool proof method for locking the electrically-operated device while a vehicle is moving to prevent the electrically-operated device from being activated. Additionally, pressing a sequence of buttons to activate an electrically-operated device is often considered cumbersome to some users. Moreover, requiring a sequence of button presses to activate an electrically-operated device does not address the possibility of a short circuit in wiring for a system including, controlling, or powering the electrically-operated device.

In a particular embodiment, a circuit-breaking system to disconnect power to one or more electrically-operated devices is provided. The circuit-breaking system may include a shut-off indicator and a relay under the control of the shut-off indicator. In a first particular embodiment, the shut-off indicator may be a sensing circuit—that is configured to be exposed to current or voltage resulting from the activation of the brake or braking circuit in a vehicle. That is, the sensing circuit may detect activation of the brake or braking circuit in a vehicle. In a second particular embodiment, the shut-off indicator includes a motion detector. The motion detector may include a mercury switch, an accelerometer, or a global positioning system (“UPS”) device, for example. The relay may be a latching relay, for example.

During operation, the shut-off indicator may send a signal to the relay and the relay may then disconnect power to the one or more electrically-operated devices. The relay may disconnect power to all electrically-operated devices hi a vehicle or the relay may disconnect power to only those electrically-operated devices that are safety-critical electrically-operated devices. In a first particular embodiment, a sensing circuit may detect an activation of a brake or braking circuit in a vehicle. The sensing circuit may then send a power-off signal to the relay to disconnect power to one or more electrically-operated devices. The sensing circuit may send the power-off signal to the relay via a wire or circuit electrically connected to the relay. Alternately, the sensing circuit may send the power-off signal to the relay wirelessly. For example, the sensing circuit may send the power-off signal to the relay via a radio frequency (“RF”) transmitter.

In a second particular embodiment, the motion detector may detect motion of the vehicle and send a power-off signal to the relay to disconnect power to one or more electrically-operated devices. The motion detector may send the power-off signal to the relay via a wire or circuit electrically connected to the relay. Alternately, the motion detector may send the power-off signal to the relay wirelessly. For example, the motion detector may send the power-off signal to the relay via an RF transmitter.

In particular embodiments, the relay and the electrically-operated devices may be located in the same vehicle as the shut-off indicator. For example, the shut-off indicator, the relay, and the electrically-operated device may all be located in an RV. In other particular embodiments, the relay and the electrically-operated devices may be located in a second vehicle. For example, a first vehicle may be towing a second vehicle and the shut-off indicator may be located in the first vehicle while the relay and one or more electrically-operated devices may be located in the vehicle being towed. In still other embodiments, multiple relays and electrically-operated devices may be located in the same vehicle as the shut-off indicator in addition to a second vehicle. For example, an RV may be towing a second vehicle. The shut-off indicator may be located in the RV and the relay and electrically-operated devices may be located in both the RV and the vehicle being towed.

After the relay has been activated to disconnect the power to an electrically-operated device to deactivate the electrically-operated device, the power can later be reconnected. For example, the electrically-operated device may be reactivated by applying a switch that reapplies power to the electrically-operated device. The switch may be a dedicated manual switch, a switch that is automatically activated by opening an entry door, or a switch that is activated by other means, for example. In other examples, the electrically-operated device may be reactivated using other means. For example, the electrically-operated device may be reactivated via a method using secure RF or secure infrared (“IR”).

In particular embodiments a control module is used to control which electrically-operated devices are disabled when a shut-off indicator provides a signal that one or more electrically-operated devices should be disabled. The shut-off indicator may be an example shut-off indicator described herein. The control module may include a shut-off input configured to receive signals from the shut-off indicator. The control module may also include one or more activator inputs configured to receive signals from activation devices that a user can use to activate or deactivate an electrically-operated device. For example, an activation device may include a remote control or an on/off switch. The control module may include one or more outputs, where each output may control power to one or more electrically-operated devices. The control module may include a processor configured to execute processor-executable instructions. The control module may also include memory, accessible to the processor, that includes processor-executable instructions that, when executed by the processor, enable the control module to perform operations and methods described herein.

During operation, the control module may receive, via the shut-off input, a shut-off signal from a shut-off indicator. As described above, the shut-off indicator may include a sensing circuit, a motion detector, or a OPS device, for example. In response to receiving the shut-off signal, the control module may selectively ignore one or more activator inputs. For example, the control module may ignore a particular activator input configured to receive signals from an activator device configured to activate or deactivate a particular electrically-operated device. While the particular activator input is ignored the activator device is unable to activate the particular electrically-operated device. In response to receiving the shut-off signal, the control module may selectively turn off or lock out any of the outputs. For example, the control module may turn off or lock out a particular output configured to control power to a particular electrically-operated device. While the particular output is turned off or lock out the particular electrically-operated device is disabled an unable to be activated.

In a first particular embodiment, the control module selectively ignores particular inputs to prevent motor functions such as jacks or awnings from being activated. The control module does not ignore other inputs, allowing functions that are not safety critical, such as lights, to activate.

In a second particular embodiment, the control module selectively ignores inputs that receive signals from remote control devices, but does not ignore inputs from manual switches, allowing the manual switches, such as can be found in a trailer or coach, to function normally. That is, the manual switches may continue to activate or deactivate electrically-operated devices.

In a third particular embodiment, the control module has default settings that determine which inputs get ignored under particular circumstances or by particular methods and which outputs get turned off or locked out under particular circumstances or by particular methods. A user may have the option to modify the settings.

A control module may reset inputs (i.e., stop ignoring them) and outputs (i.e., turn them back on or unlock them) in a variety of ways. In a first particular embodiment, a control module resets an input or an output after a particular amount of time has elapsed. In a second particular embodiment, a control module resets an input or an output when a manual switch is thrown or pressed, for example. In a third particular embodiment, a control module resets an input or an output when a unique combination of button presses on a remote is detected. In a fourth particular embodiment, a control module uses a motion sensor to reset an input or output. For example, the control module may reset an input or an output when the control module has detected that a particular period of time has elapsed since a vehicle has moved.

What is claimed is:

1. In a vehicle having at least one electrically activated and operated device such as an electrically operated jack system, a safety shut off device comprising:
a. a controller that is automatically activated in response to an act occurring within that or a second vehicle associated with said first vehicle, to provide a RF shutdown signal,
b. a RF receiver responsive to the activation of the controller to provide a second signal, and
c. an electrical means associated with said electrically activated and operated device said electrical means being responsive to said second signal to shut down and de-energize said device until reactivated by an operator of said vehicle.

2. The safety shut down device of claim 1, wherein said first vehicle is an RV.

3. The safety shut down device of claim 2, wherein including a first vehicle that is an RV that is towed and the second vehicle is a towing vehicle.

4. The safety shut office device of claim 1 wherein said act is applying pressure to a braking system.

5. The safety shut off device of claim 1 wherein said act is the vehicle starting in motion.
